(19) United States
(12) Patent Application Publication
(10) Pub. No.: US 2023/0393262 A1
(43) Pub. Date: Dec. 7, 2023

(54) COMMUNICATION APPARATUS

(71) Applicant: Toshiba Tec Kabushiki Kaisha, Tokyo (JP)

(72) Inventors: Koki NAKAMURA, Mishima Shizuoka (JP); Jun YAGINUMA, Izunokuni Shizuoka (JP); Hiroyuki ISHIKAWA, Sunto Shizuoka (JP)

(21) Appl. No.: 18/165,053

(22) Filed: Feb. 6, 2023

(30) Foreign Application Priority Data
Jun. 1, 2022 (JP) 2022-089645

(51) Int. Cl. G01S 13/75

(52) U.S. Cl. CPC G01S 13/75; H04W 16/28

(57) ABSTRACT

According to an embodiment, a communication apparatus communicates with a wireless tag using one or more antennas. The communication apparatus determines a position of the wireless tag on the basis of tag data of the wireless tag acquired on the basis of movement of the antenna along the first direction and tag data of the wireless tag acquired on the basis of movement of the antenna or a different antenna along the second direction.

### CROSS-REFERENCE TO RELATED APPLICATIONS

This application is based upon and claims the benefit of priority from the prior Japanese Patent Application No. 2022-089645, filed on Jun. 1, 2022, the entire contents of which are incorporated herein by reference.

### FIELD

An embodiment to be described here generally relates to a communication apparatus.

### BACKGROUND

In recent years, a wireless tag is increasingly attached to an article instead of attaching a barcode to an article. In this case, a wireless reader/writer reads information stored in the wireless tag through wireless communication with the wireless tag.

Further, the wireless reader/writer measures the phase at a plurality of relative positions of an antenna with respect to the wireless tag on the basis of a response wave from the wireless tag. The phase is used to determine the position of the wireless tag.

However, the characteristics of the phase are similar in some cases even when the position of the wireless tag differs. In such a case, it is difficult to determine the position of the wireless tag.

### BRIEF DESCRIPTION OF THE DRAWINGS

FIG. 1 is a block diagram showing an example of a configuration of a communications system according to a first embodiment;

FIG. 2 is a block diagram showing an example of a configuration of a reading device according to the first embodiment;

FIG. 3 is a block diagram showing an example of a configuration of a drive device according to the first embodiment;

FIG. 4 is a schematic diagram for describing the drive device according to the first embodiment;

FIG. 5 is a top view for describing movement of an antenna according to the first embodiment along a first direction;

FIG. 6 is a top view for describing movement of the antenna according to the first embodiment along a second direction;

FIG. 7 is a top view for describing an example of determining a position of a wireless tag according to the first embodiment;

FIG. 8 is a graph of the phase acquired by the reading device according to the first embodiment;

FIG. 9 is a flowchart showing an example of processing performed by a processor of the reading device according to the first embodiment;

FIG. 10 is a block diagram showing an example of a configuration of a communications system according to the second embodiment;

FIG. 11 is a schematic diagram for describing a drive device according to a second embodiment;

FIG. 12 is a top view for describing movement of a first antenna and a second antenna according to the second embodiment;

FIG. 13 is a side view for describing movement of the first antenna and the second antenna according to the second embodiment;

FIG. 14 is a flowchart showing an example of processing performed by a processor of a reading device according to the second embodiment; and

FIG. 15 is a flowchart showing an example of movement end processing performed by the processor of the reading device according to the second embodiment.

### DETAILED DESCRIPTION

According to an embodiment, a communication apparatus includes: one or more antennas, a first driving device, a second driving device, and a processor. The one or more antennas communicate with a wireless tag. The first driving device causes an antenna to move in a first direction. The second driving device causes the antenna or a different antenna different from the antenna in a second direction different from the first direction. The processor is configured to determine a position of the wireless tag on the basis of tag data of the wireless tag acquired on the basis of movement of the antenna along the first direction and tag data of the wireless tag acquired on the basis of movement of the antenna or the different antenna along the second direction.

### First Embodiment

Embodiments will be described with reference to the drawings. Note that in the drawings used for describing the following embodiments, the scale of the respective units is appropriately changed in some cases. Further, in the drawings used for describing the following embodiments, configurations are omitted in some cases for description. In the drawings, the same reference symbols denote the same or similar portions.

[Configuration Example]

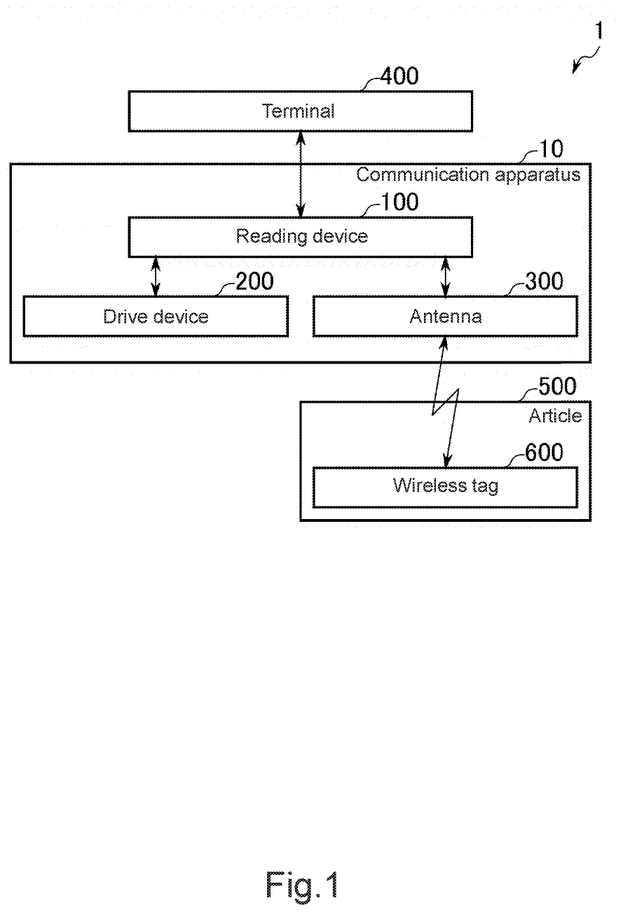

FIG. 1 is a block diagram showing an example of a configuration of a communications system 1. The communications system 1 includes a communication apparatus 10, a terminal 400, and one or more wireless tags 600 attached to one or more articles 500. Although one wireless tag 600 attached to one article 500 is shown in FIG. 1, the communications system 1 may include a plurality of wireless tags 600 attached to a plurality of articles 500. Note that the communications system 1 includes the communication apparatus 10 and the terminal 400, but does not need to include the one or more articles 500. The communications system 1 is an example of an information processing system.

The communication apparatus 10 is an apparatus that performs wireless communication with the wireless tag 600. The communication apparatus 10 can be used for inspection of the like in a warehouse but may be used in a store. The application example of the communication apparatus 10 is not limited thereto. The communication apparatus 10 includes a reading device 100, a drive device 200, and an antenna 300.

The reading device 100 is a device that controls the drive device 200 and the antenna 300 to read information from the wireless tag 600. Further, the reading device 100 is also a device that controls the drive device 200 and the antenna 300 to measure tag data of the wireless tag 600. The measurement includes the meaning of detection. The tag data includes at least a phase and a received signal strength indicator (RSSI). A configuration example of the reading device 100 will be described below.

The drive device 200 is a device that causes the antenna 300 to move. Causing the antenna 300 to move includes causing the position of the antenna 300 to move.

The drive device 200 causes the antenna 300 between a position A and a position B on a straight line along a first direction. The drive device 200 causes the antenna 300 to move between a position C and a position D on a straight line along a second direction. The second direction is a direction different from the first direction. Here, an example in which the first direction and the second direction are horizontal to each other will be described. A configuration example of the drive device 200 will be described below.

The antenna 300 communicates with the wireless tag 600. The antenna 300 transmits a radio wave. The antenna 300 receives the radio wave from the wireless tag 600. The radio wave from the wireless tag 600 is an example of a response wave from the wireless tag 600 in response to the radio wave transmitted from the antenna 300. The antenna 300 converts the radio wave received from the wireless tag 600 into a high frequency signal and outputs the high frequency signal to the reading device 100.

The terminal 400 is an apparatus that processes information read from the wireless tag 600 by the reading device 100. The terminal 400 is a personal computer (PC) or the like, but is not limited thereto as long as it is an apparatus that processes data. The article 500 is a product or the like.

The wireless tag 600 is a target for determining the position of the wireless tag 600. Determining the position of the wireless tag 600 includes determining a region where the position of the wireless tag 600 is present. Determining a region where the position of the wireless tag 600 is present includes determining whether or not the position of the wireless tag 600 is included in a first region. Determining whether or not the position of the wireless tag 600 is included in the first region includes determining in which of the first region and a second region the position of the wireless tag 600 is included. The first region and the second region are different regions that do not overlap with each other. For example, the first region and the second are each a three-dimensional region. The first region and the second region may be adjacent to each other or do not need to be adjacent to each other. The region includes the meaning of a range. The first region is an example of a predetermined region. An example of the first region and the second region will be described below.

The wireless tag 600 is an IC tag that includes an IC chip and an antenna. The wireless tag 600 is typically a radio frequency identification (RFID) tag. The wireless tag 600 may be another IC tag. The wireless tag 600 is a passive wireless tag that operates using, as an energy source, the radio wave transmitted from the antenna 300. The wireless tag 600 performs backscatter modulation on an unmodulated signal to transmit, via the antenna, a signal that contains information stored in the IC chip of the wireless tag 600. The information stored in the wireless tag 600 may include information that can be uniquely identified. The information stored in the wireless tag 600 may include information regarding the article 500 to which the wireless tag 600 has been attached.

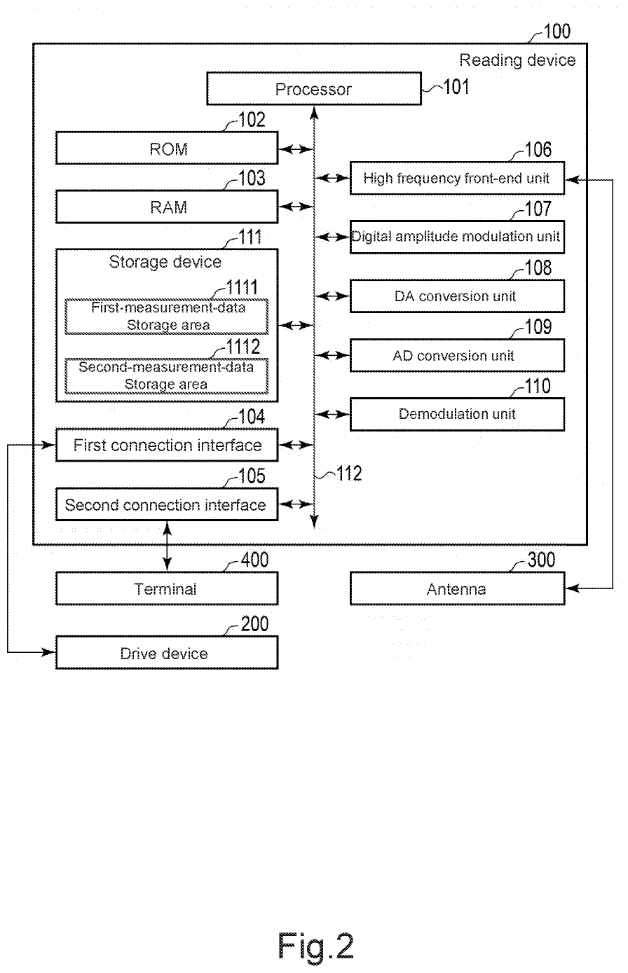

The reading device 100 will be described with reference to FIG. 2. FIG. 2 is a block diagram showing an example of a configuration of the reading device 100. The reading device 100 includes a processor 101, a read-only memory (ROM) 102, a random-access memory (RAM) 103, a first connection interface 104, a second connection interface 105, a high frequency front-end unit 106, a digital amplitude modulation unit 107, a digital-to-analog (DA) conversion unit 108, an analog-to-digital (AD) conversion unit 109, a demodulation unit 110, and a storage device 111. The respective units included in the reading device 100 are connected to each other via a bus 112 or the like.

The processor 101 corresponds to the brain of a computer that perform processing such as calculation and control necessary for the operation of the reading device 100. The processor 101 develops various programs stored in the ROM 102, the storage device 111, or the like into the RAM 103. The processor 101 executes the program developed into the RAM 103 to execute various types of processing.

The processor 101 is a central processing unit (CPU), a micro processing unit (MPU), a system on a chip (SoC), a digital signal processor (DSP), a graphics processing unit (GPU), an application specific integrated circuit (ASIC), a programmable logic device (PLD), a field-programmable gate array (FPGA), or the like. The processor 101 may be a combination of these.

The ROM 102 corresponds to a main storage device of the computer with the processor 101 as the brain thereof. The ROM 102 is a non-volatile memory used exclusively for reading data. The ROM 102 stores the program described above. Further, the ROM 102 stores data to be used by the processor 101 for performing various types of processing, various setting values, or the like.

The RAM 103 corresponds to a main storage device of the computer with the processor 101 as the brain thereof. The RAM 103 is a memory to be used for reading/writing data. The RAM 103 is a work area for storing data to be temporarily used by the processor 101 for performing various types of processing. The RAM 103 is an example of a storage unit.

The first connection interface 104 is an interface for the reading device 100 to communicate with the drive device 200.

The second connection interface 105 is an interface for the reading device 100 to communicate with the terminal 400.

The high frequency front-end unit 106 outputs a high frequency signal to the antenna 300. A high frequency signal is input from the antenna 300 to the high frequency front-end unit 106.

The digital amplitude modulation unit 107 is a circuit for adding, to a carrier wave to be transmitted to the wireless tag 600, data to be transmitted to the wireless tag 600.

The DA conversion unit 108 is a circuit for converting a digital signal into an analog signal. The DA conversion unit 108 converts the digital signal modulated by the digital amplitude modulation unit 107 into an analog signal. The DA conversion unit 108 outputs a high frequency signal to the antenna 300 via the high frequency front-end unit 106.

The AD conversion unit 109 is a circuit for converting an analog signal into a digital signal. The AD conversion unit 109 converts the high frequency signal input from the antenna 300 via the high frequency front-end unit 106 into a digital signal.

The demodulation unit 110 is a circuit for acquiring information on the basis of the radio wave from the wireless tag 600 received by the antenna 300. For example, the demodulation unit 110 acquires information stored in the wireless tag 600 from the digital signal converted by the AD conversion unit 109, by a known technology. The demodulation unit 110 is an example of an information acquisition unit that acquires information stored in the wireless tag 600 on the basis of the radio wave from the wireless tag 600. Acquiring information stored in the wireless tag 600 on the basis of the radio wave from the wireless tag 600 is an example of reading information from the wireless tag 600 on the basis of the radio wave from the wireless tag 600.

The demodulation unit 110 is also a circuit for measuring tag data on the basis of the radio wave from the wireless tag 600 received by the antenna 300. The demodulation unit 110 is capable of measuring the phase of a radio wave in chronological order from the digital signal converted by the AD conversion unit 109, by a known technology. The demodulation unit 110 is an example of a measurement unit that measures the phase of a radio wave on the basis of the radio wave from the wireless tag 600 received by the antenna 300. The demodulation unit 110 is capable of measuring a received signal strength indicator of a radio wave in chronological order from the digital signal converted by the AD conversion unit 109, by a known technology. The demodulation unit 110 is an example of a measurement unit that measures a received signal strength indicator of a radio wave on the basis of the radio wave from the wireless tag 600 received by the antenna 300.

The storage device 111 is a device that includes a non-volatile memory for storing data, a program, and the like. The storage device 111 includes a hard disk drive (HDD), a solid state drive (SSD), or the like, but is not limited thereto. The storage device 111 is an example of a storage unit.

The storage device 111 includes a first-measurement-data storage area 1111. The first-measurement-data storage area 1111 stores first measurement data. The first measurement data is data measured by the demodulation unit 110 on the basis of the control of first measurement processing by the processor 101. The first measurement processing is measurement of tag data of the one or more wireless tags 600 based on movement of the antenna 300 along the first direction. The processor 101 acquires tag data of each of the one or more wireless tags 600 on the basis of movement of the antenna 300 along the first direction in the first measurement processing.

The first measurement data includes a first tag data set for each wireless tag 600. The first tag data set is a collection of one or more pieces of tag data of the wireless tag 600 measured by the demodulation unit 110. The first tag data set includes a plurality of pieces of tag data of the antenna 300 at a plurality of positions between the position A and the position B. The plurality of positions of the antenna 300 may include positions spaced at regular intervals between the position A and the position B. The value of the regular intervals can be appropriately set. The demodulation unit 110 measures tag data for all positions spaced at regular intervals between the position A and the position B in accordance with the wireless tag 600 in some cases. The demodulation unit 110 measures tag data for only part of the positions spaced at regular intervals between the position A and the position B in accordance with the wireless tag 600 in some cases. The first measurement data can be updated each time the first measurement processing is performed.

The storage device 111 includes a second-measurement-data storage area 1112. The second-measurement-data storage area 1112 stores second measurement data. The second measurement data is data measured by the demodulation unit 110 on the basis of the control of second measurement processing by the processor 101. The second measurement processing is measurement of tag data of the one or more wireless tags 600 based on movement of the antenna 300 along the second direction. The processor 101 acquires, in the second measurement processing, tag data of each of the one or more wireless tags 600 on the basis of movement of the antenna 300 along the second direction.

The second measurement data includes a second tag data set for each wireless tag 600. The second tag data set is a collection of one or more pieces of tag data of the wireless tag 600 measured by the demodulation unit 110. The second tag data set includes a plurality of pieces of tag data of the antenna 300 at a plurality of positions between the position C and the position D. The plurality of positions of the antenna 300 may include positions spaced at regular intervals between the position C and the position D. The value of the regular intervals can be appropriately set. The demodulation unit 110 measures tag data for all positions spaced at regular intervals between the position C and the position D in accordance with the wireless tag 600 in some cases. The demodulation unit 110 measures tag data for only part of the positions spaced at regular intervals between the position C and the position D in accordance with the wireless tag 600 in some cases. The second measurement data can be updated each time the second measurement processing is performed.

Now, an example of processing of determining the position of each wireless tag 600 by the processor 101 will be described. The processor 101 determines the position of the wireless tag 600 on the basis of tag data of the wireless tag 600 acquired on the basis of movement of the antenna 300 along the first direction and tag data of the wireless tag 600 acquired on the basis of movement of the antenna 300 along the second direction. For example, the processor 101 determines the position of the antenna 300, which is an inflection point in the first direction, on the basis of the plurality of pieces of tag data of the antenna 300 at the plurality of positions included in the first tag data set of the wireless tag 600. The inflection point represents a position of the antenna 300 where the slope of tag data is reversed. The position of the antenna 300, which is an inflection point in the first direction, is a position where the wireless tag 600 is present in the first direction. In the following, the position of the antenna 300, which is an inflection point in the first direction, will be referred to also as a position of the inflection point in the first direction. The processor 101 determines the position of the antenna 300, which is an inflection point in the second direction, on the basis of the plurality of pieces of tag data of the antenna 300 at the plurality of positions included in the second tag data set of the wireless tag 600. The position of the antenna 300, which is an inflection point in the second direction, is a position where the wireless tag 600 is present in the second direction. In the following, the position of the antenna 300, which is an inflection point in the second direction, will be referred to also as a position of the inflection point in the second direction.

The processor 101 determines the position of the wireless tag 600 on the basis of the position of the inflection point in the first direction and the position of the inflection point in the second direction. The processor 101 is capable of determining, as a region where the position of the wireless tag 600 is present, a region that includes both the position of the inflection point in the first direction and the position of the inflection point in the second direction. As illustrated below, the processor 101 is capable of determining whether or not the position of the wireless tag 600 is included in the first region. For example, the processor 101 determines whether or not the position of the inflection point in the first direction is included in the first region in the first direction. The processor 101 determines whether or not the position of the inflection point in the second direction is included in the first region in the second direction. In the case where both the position of the inflection point in the first direction and the position of the inflection point in the second direction are included in the first region, the processor 101 determines that the position of the wireless tag 600 is included in the first region. Meanwhile, in the case where at least one of the position of the inflection point in the first direction or the position of the inflection point in the second direction is not included in the first region, the processor 101 determines that the position of the wireless tag 600 is not included in the first region. The processor 101 may determine, in the case where it is determined that the position of the wireless tag 600 is not included in the first region, that the position of the wireless tag 600 is included in the second region. As a result, the processor 101 is capable of determining in which of the first region and the second region the position of the wireless tag 600 is included.

Note that although an example in which the storage device 111 stores first measurement data and second measurement data has been described, the present technology is not limited thereto. The RAM 103 may store first measurement data and second measurement data.

The bus 112 includes a control bus, and address bus, a data bus, and the like. The bus 112 transmits signals to be transmitted/received by the respective units of the reading device 100.

Note that the hardware configuration of the reading device 100 is not limited to the above-mentioned configuration. In the reading device 100, the above-mentioned components can be omitted and changed and new components can be added, as necessary.

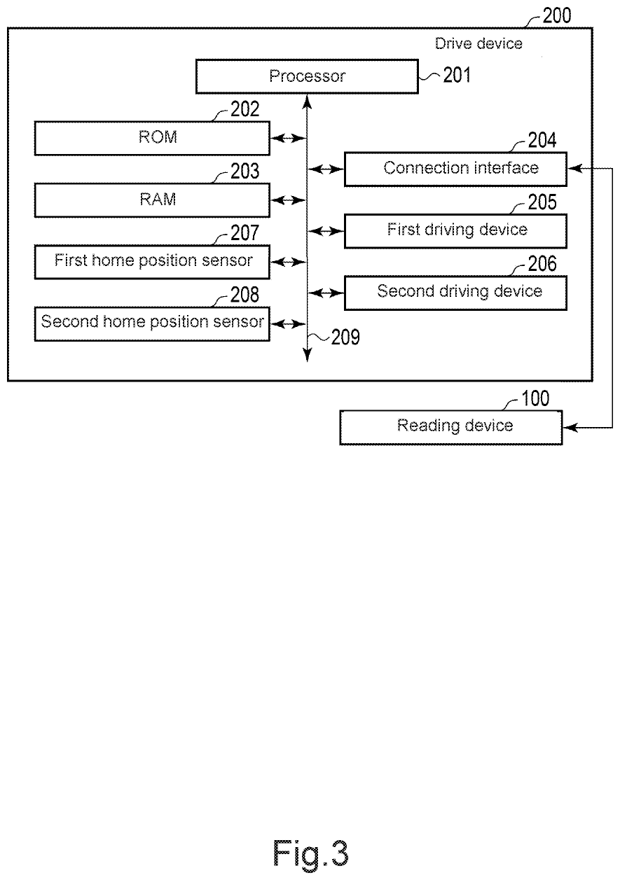

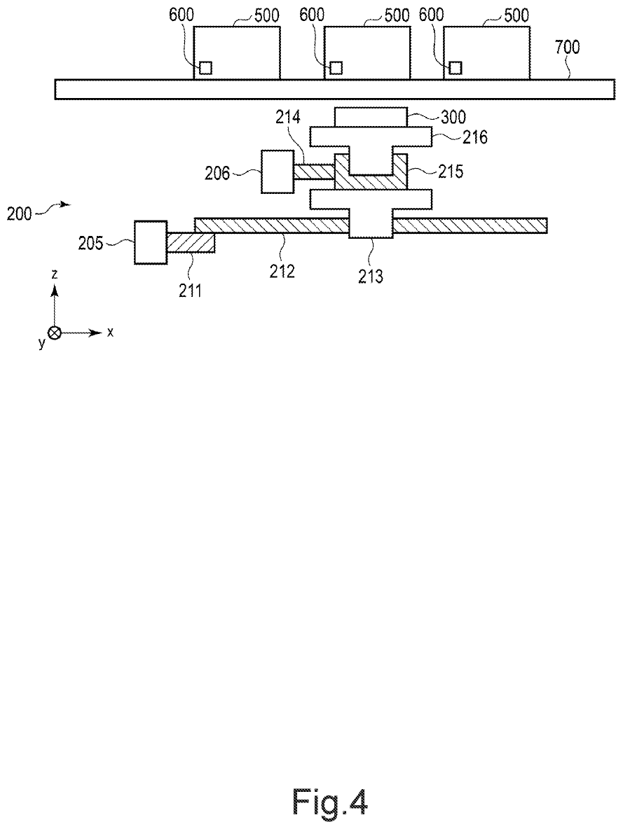

The drive device 200 will be described with reference to FIG. 3 and FIG. 4. FIG. 3 is a block diagram showing an example of a configuration of the drive device 200. The drive device 200 includes a processor 201, a ROM 202, a RAM 203, a connection interface 204, a first driving device 205, a second driving device 206, a first home position sensor 207, and a second home position sensor 208. The respective units included in the drive device 200 are connected to each other via a bus 209 or the like.

The processor 201 corresponds to the brain of a computer that perform processing such as calculation and control necessary for the operation of the drive device 200. The processor 201 develops various programs stored in the ROM 202 or the like into the RAM 203. The processor 201 executes the program developed into the RAM 203 to execute various types of operations. The processor 201 is a CPU, an MPU, a SoC, a DSP, a GPU, an ASIC, a PLD, an FPGA, or the like. The processor 201 may be a combination of these.

The ROM 202 corresponds to a main storage device of the computer with the processor 201 as the brain thereof. The ROM 202 is a non-volatile memory used exclusively for reading data. The ROM 202 stores the program described above. The ROM 202 stores data to be used by the processor 201 for performing various types of processing, various setting values, or the like.

The RAM 203 corresponds to a main storage device of the computer with the processor 201 as the brain thereof. The RAM 203 is a memory to be used for reading/writing data. The RAM 103 is a work area for storing data to be temporarily used by the processor 201 for performing various types of processing.

The connection interface 204 is an interface for the drive device 200 to connect to the reading device 100.

The first driving device 205 causes the antenna 300 to move in the first direction. For example, the first driving device 205 is a stepping motor.

The second driving device 206 causes the antenna 300 to move in the second direction. For example, the second driving device 206 is a stepping motor.

The first home position sensor 207 is a sensor that detects whether or not a first moving stage 213 described below is at a first start position. The first start position is a position where the antenna 300 is caused to start moving for first measurement processing. Assumption is made that the first start position is the position A. In the case where the first start position is the position A, a first end position where the antenna 300 is caused to stop moving for first measurement processing is the position B.

The second home position sensor 208 is a sensor that detects whether or not a second moving stage 216 described below is at a second start position. The second start position is a position where the antenna 300 is caused to start moving for second measurement processing. Assumption is made that the second start position is the position C. In the case where the second start position is the position C, a second end position where the antenna 300 is caused to stop moving for second measurement processing is the position D.

The bus 209 includes a control bus, an address bus, a data bus, and the like. The bus 209 transmits signals to be transmitted/received by the respective units of the drive device 200.

FIG. 4 is a schematic diagram for describing the drive device 200. As illustrated in FIG. 4, the drive device 200 and the antenna 300 are disposed below a counter table 700. The counter table 700 is a table having a horizontal surface on which the article 500 to which the wireless tag 600 has been attached is placed. The counter table 700 is an example of a placement portion. The counter table 700 may be included in the communications system 1 or the communication apparatus 10.

The drive device 200 includes a first rotation shaft 211, a first rail 212, the first moving stage 213, a second rotation shaft 214, a second rail 215, and the second moving stage 216.

The first rail 212 extends along the first direction. Here, the direction along the x-axis on the horizontal surface shown in FIG. 4 is the first direction. The first moving stage 213 is attached to the first rail 212. The second rail 215 is attached to the first moving stage 213. The second rail 215 extends in the second direction. Here, the direction along the y-axis on the horizontal surface orthogonal to the x-axis is a second direction. Note that the second direction does not necessarily need to be orthogonal to the first direction. The second moving stage 216 on which the antenna 300 is placed is attached to the second rail 215.

The first rotation shaft 211 transmits driving force of the first driving device 205. A screw groove is formed in each of the first rotation shaft 211 and the first rail 212. The screw groove of the first rotation shaft 211 and the screw groove of the first rail 212 are connected facing each other. For this reason, when the first driving device 205 rotates and drives, the first rotation shaft 211 rotates and the first rail 212 rotates. The first moving stage 213 includes a ball screw nut. When the first rail 212 rotates, the first moving stage 213 moves in the first direction along the first rail 212 by the ball screw nut. The first moving stage 213 moves back and forth along the first direction in accordance with the rotation direction of the first rail 212. In this way, the first driving device 205 is capable of causing the antenna 300 to move in the first direction.

The second rotation shaft 214 transmits driving force of the second driving device 206. A screw groove is formed in each of the second rotation shaft 214 and the second rail 215. The screw groove of the second rotation shaft 214 and the screw groove of the second rail 215 are connected facing each other. For this reason, when the second driving device 206 rotates and drives, the second rotation shaft 214 rotates and the second rail 215 rotates. The second moving stage 216 includes a ball screw nut. When the second rail 215 rotates, the second moving stage 216 moves in the second direction along the second rail 215 by the ball screw nut. The second moving stage 216 moves back and forth along the second direction in accordance with the rotation direction of the second rail 215. In this way, the second driving device 206 is capable of causing the antenna 300 to move in the second direction.

Note that although the antenna 300 is placed on the second moving stage 216 in the example shown in FIG. 4, the present technology is not limited thereto. The antenna 300 may be placed on the first moving stage 213. In this example, the order of the first moving stage 213 and the second moving stage 216 in the vertical direction along the z-axis shown in FIG. 4 may be reversed. The first rail 212 is attached to the second moving stage 216. The first moving stage 213 on which the antenna 300 is been placed is attached to the first rail 212.

Note that the hardware configuration of the drive device 200 is not limited to the above-mentioned configuration. In the drive device 200, the above-mentioned components can be omitted and changed and new components can be added, as necessary.

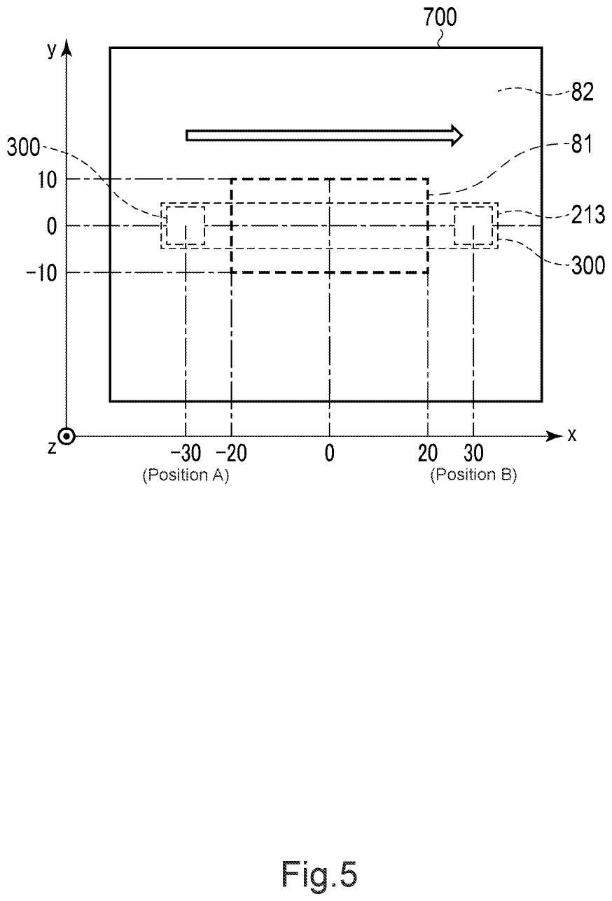

An example of movement of the antenna 300 along the first direction will be described. FIG. 5 is a top view for describing movement of the antenna 300 along the first direction.

A first region 81 is a region set in the central portion of the horizontal surface of the counter table 700. A second region 82 is a region other than the first region 81, which surrounds the first region 81. The first region 81 and the second region 82 are regions separated in the horizontal direction. Although the second region 82 is adjacent to the first region 81 in the horizontal direction in FIG. 5, the present technology is not limited thereto. The second region 82 may be set spaced apart from the first region 81 without being adjacent thereto. Although the shape of the first region 81 on the horizontal surface is described here as a rectangular shape defined by a straight line along the x-axis and a straight line along the y-axis, the shape of the first region 81 is not limited to a rectangular shape.

The position of x=0 [cm] is an example of an intermediate position of the first region 81 in the first direction. The position of x=−20 [cm] is an example of a position of a first end of the first region 81 in the first direction. The position of x=20 [cm] is an example of a position of a second end of the first region 81 in the first direction. The second end in the first direction is an end of the first region 81 on the side opposite to the first end in the first direction. In the first direction, positions between the position of the first end in the first direction and the position of the second end in the first direction are positions inside the first region 81. The position of x=−30 [cm] is an example of a position of the first region 81 outside the first end in the first direction. Assumption is made that the position of the first region 81 outside the first end in the first direction is the position A. The position of x=30 [cm] is an example of a position of the first region 81 outside the second end in the first direction. Assumption is made that the position of the first region 81 outside the second end in the first direction is the position B.

The position of y=0 [cm] is an example of an intermediate position of the first region 81 in the second direction. The position of y=10 [cm] is an example of a position of a first end of the first region 81 in the second direction. The position of x=−10 [cm] is an example of a position of a second end of the first region 81 in the second direction. The second end in the second direction is an end of the first region 81 on the side opposite to the first end in the second direction. In the second direction, positions between the position of the first end in the second direction and the position of the second end in the second direction are positions inside the first region 81.

The first driving device 205 causes, in first measurement processing, the antenna 300 to move from the outside of one end of the first region 81 in the first direction to the outside of the other end in the first direction. FIG. 5 shows an example of the trajectory of the first moving stage 213 that causes the antenna 300 to move. A case where the first start position is the position A and the first end position is the position B will be described. The first driving device 205 causes the antenna 300 to move from the position A outside the first end of the first region 81 in the first direction to the position B outside the second end of the first region 81 in the first direction. Note that the first start position and the first end position may be reversed. In this example, the first start position is the position B and the first end position is the position A. The first driving device 205 causes the antenna 300 to move from the position B outside the second end of the first region 81 in the first direction to the position A outside the first end of the first region 81 in the first direction.

Although the first driving device 205 causes the antenna 300 to move in the first direction so as to face, in the vertical direction, the intermediate position of the first region 81 in the second direction in the example shown in FIG. 5, the present technology is not limited thereto. The first driving device 205 may cause the antenna 300 to move in the first direction so as to face, in the vertical direction, an arbitrary position of the first region 81 in the second direction. The first driving device 205 may cause the antenna 300 to move in the first direction without facing the first region 81 in the vertical direction.

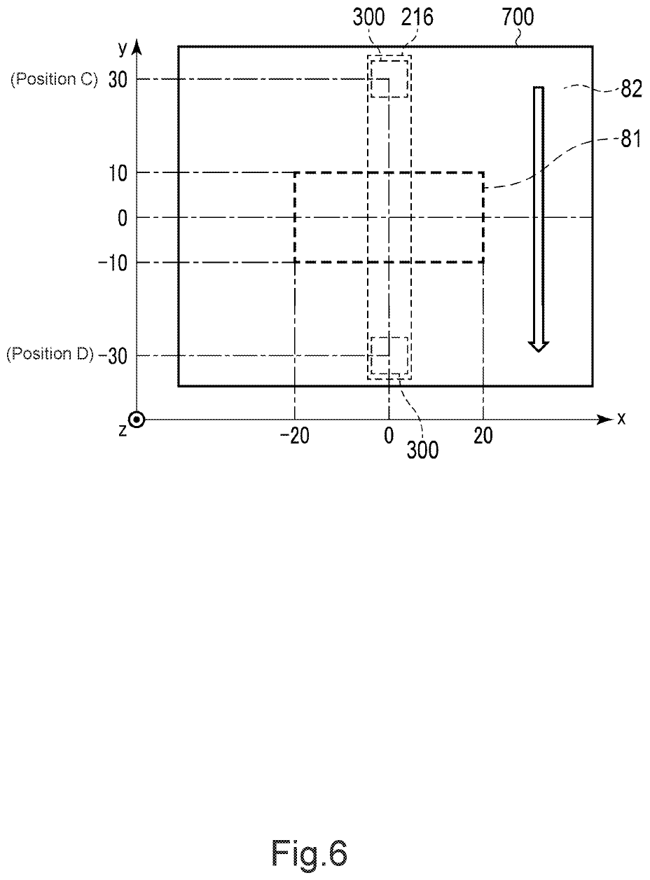

An example of movement of the antenna 300 along the second direction will be described. FIG. 6 is a top view for describing movement of the antenna 300 along the second direction.

The position of y=30 [cm] is an example of a position of the first region 81 outside the first end in the second direction. Assumption is made that the position of the first region 81 outside the first end in the second direction is the position C. The position of y=−30 [cm] is an example of a position of the first region 81 outside the second end in the second direction. Assumption is made that the position of the first region 81 outside the second end in the second direction is the position D.

The second driving device 206 causes, in second measurement processing, the antenna 300 to move from the outside of one end of the first region 81 in the second direction to the outside of the other end in the second direction. FIG. 6 shows an example of the trajectory of the second moving stage 216 that causes the antenna 300 to move. A case where the second start position is the position C and the second end position is the position D will be described. The second driving device 206 causes the antenna 300 to move from the position C outside the first end of the first region 81 in the second direction to the position D outside the second end of the first region 81 in the second direction. Note that the second start position and the second end position may be reversed. In this example, the second start position is the position D and the second end position is the position C. The second driving device 206 causes the antenna 300 to move from the position D outside the second end of the first region 81 in the second direction to the position C outside the first end of the first region 81 in the second direction.

Although the second driving device 206 causes the antenna 300 to move in the second direction so as to face, in the vertical direction, the intermediate position of the first region 81 in the first direction in the example of FIG. 6, the present technology is not limited thereto. The second driving device 206 may cause the antenna 300 to move in the second direction so as to face, in the vertical direction, an arbitrary position of the first region 81 in the first direction. The second driving device 206 may cause the antenna 300 to move in the second direction without facing the first region 81 in the vertical direction.

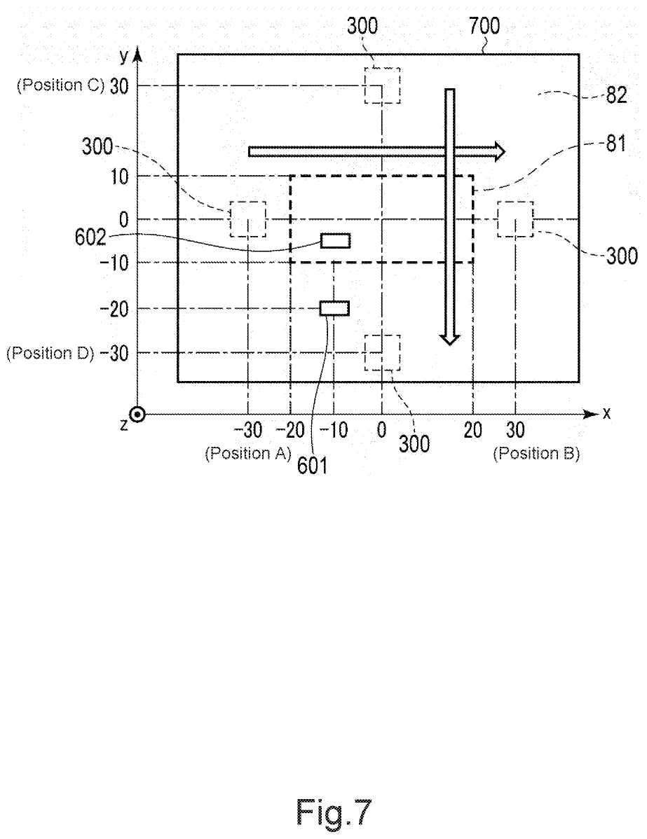

An example of determining the position of the wireless tag 600 will be described. FIG. 7 is a top view for describing an example of determining the position of the wireless tag 600. A wireless tag 601 and a wireless tag 602 shown in FIG. 7 are each an example of the above-mentioned wireless tag 600. Here, these wireless tags are denoted by different reference symbols for convenience of description.

The wireless tag 601 and the wireless tag 602 are placed on the counter table 700. Assumption is made that the wireless tag 601 is located outside the first region 81. The position of the wireless tag 601 satisfies the relationships of x=−10 [cm] and y=−20 [cm]. The wireless tag 602 is located in the first region 81. The position of the wireless tag 602 satisfies the relationships of x=−10 [cm] and y=−[cm].

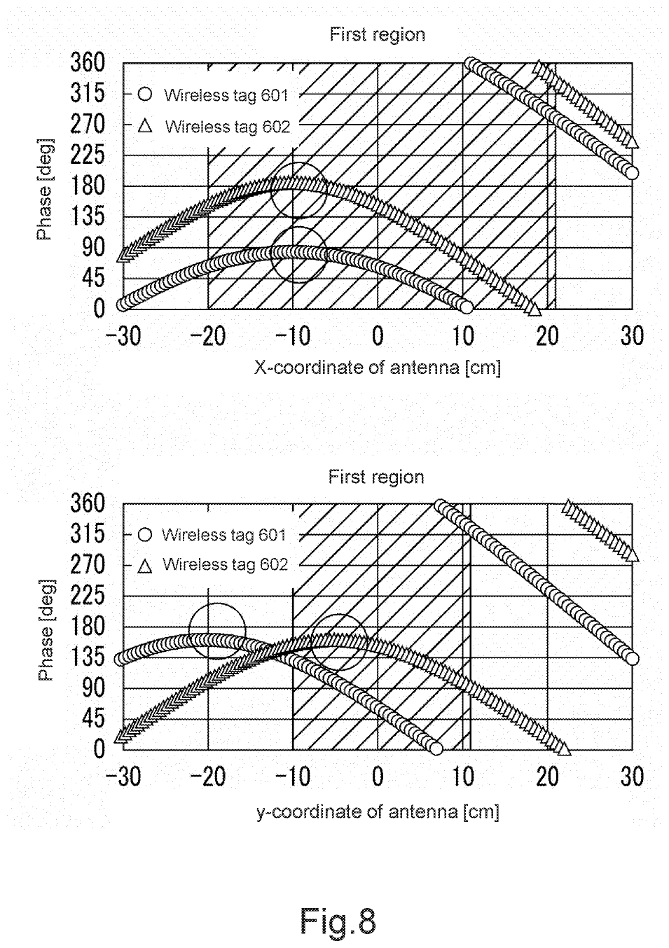

FIG. 8 is a graph of the phase acquired by the reading device 100. Although a phase will be described here as an example of tag data, the same applies to a received signal strength indicator.

The upper graph of FIG. 8 is a graph showing the phase of the wireless tag 601 and the phase of the wireless tag 602 for each position of the antenna 300 along the first direction acquired by the reading device 100 in first measurement processing. The horizontal axis indicates the x-axis position of the antenna 300 along the first direction. The vertical axis indicates the phase. Circled portions each indicate the position of the inflection point in the first direction.

The phase of the wireless tag 601 changes as the position of the antenna 300 changes. This is because the distance between the antenna 300 and the wireless tag 601 changes as the antenna 300 moves. For this reason, the graph of the phase of the wireless tag 601 for each position of the antenna 300 has a characteristic tendency that an inflection point is present. The position of the inflection point in the first direction is a position of x=−10 [cm] for the wireless tag 601. The position of the inflection point in the first direction is included in the first region 81 in the first direction for the wireless tag 601. Similarly, the phase of the wireless tag 602 changes as the position of the antenna 300 changes. For this reason, the graph of the phase of the wireless tag 602 for each position of the antenna 300 has a characteristic tendency that an inflection point is present. The position of the inflection point in the first direction is a position of x=−10 [cm] for the wireless tag 602. The position of the inflection point in the first direction is included in the first region 81 in the first direction for the wireless tag 602.

The lower graph of FIG. 8 is a graph showing the phase of the wireless tag 601 and the phase of the wireless tag 602 for each position of the antenna 300 along the second direction acquired by the reading device 100 in second measurement processing. The horizontal axis indicates the y-axis position of the antenna 300 along the second direction. The vertical axis indicates the phase. Circled portions each indicate the position of the inflection point in the second direction.

The position of the inflection point in the second direction is a position of y=−20 [cm] for the wireless tag 601. The position of the inflection point in the second direction is not included in the first region 81 in the second direction for the wireless tag 601. The position of the inflection point in the second direction is a position of y=−5 [cm] for the wireless tag 602. The position of the inflection point in the second direction is included in the first region 81 in the second direction for the wireless tag 602.

As described above, the position of the inflection point in the first direction is included in the first region 81 for the wireless tag 601, but the position of the inflection point in the second direction is not included in the first region 81. For this reason, the processor 101 determines that the position of the wireless tag 601 is not included in the first region 81. Both the position of the inflection point in the first direction and the position of the inflection point in the second direction are included in the first region 81 for the wireless tag 602. For this reason, the processor 101 determines that the position of the wireless tag 602 is included in the first region 81.

As a Comparative Example, processing of determining a position based on tag data acquired along only the first direction will be described using the wireless tag 601 as an example. Assumption is made that the processor 101 determines the position of the wireless tag 601 on the basis of tag data of the wireless tag 601 acquired on the basis of movement of the antenna 300 along the first direction. In this example, as described above, the position of the inflection point in the first direction is included in the first region 81 for the wireless tag 601. For this reason, the processor 101 determines that the position of the wireless tag 600 is included in the first region 81. Meanwhile, in the first embodiment, the processor 101 uses both the first direction and the second direction. Therefore, the processor 101 is capable of reducing the erroneous determination of the position of the wireless tag 600.

[Operation Example]

Next, processing performed by the processor 101 of the reading device 100 configured as described above will be described. Note that the processing procedure described below is merely an example, and each process may be changed as much as possible. Further, in the processing procedure described below, Steps can be omitted, replaced, and added as appropriate in accordance with the embodiment.

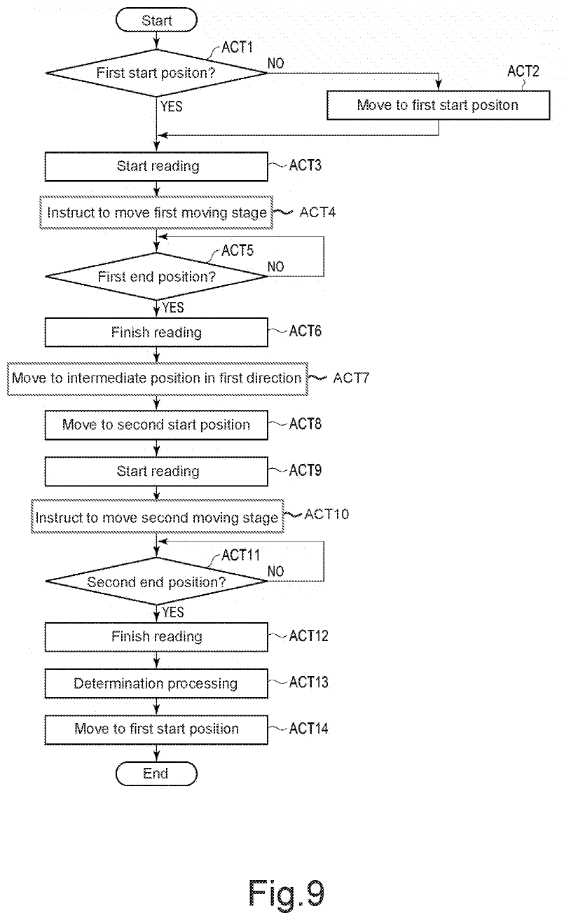

FIG. 9 is a flowchart showing an example of processing performed by the processor 101 of the reading device 100.

For example, assumption is made that the one or more articles 500 to which the one or more wireless tags 600 have been attached are placed on the counter table 700. Note that the one or more articles 500 to which the one or more wireless tags 600 have been attached do not necessarily need to be placed on the counter table 700. Part or all of the one or more wireless tags 600 may be present in the vicinity of the counter table 700.

The processor 101 may start processing on the basis of the acquisition of an instruction to start processing input by a user through the terminal 400.

In ACT1 in FIG. 9, the processor 101 determines whether or not the antenna 300 is at the position A that is the first start position. In the case where the antenna 300 is not at the first start position (ACT1, NO), the processing of the processor 101 proceeds from ACT1 to ACT2. In the case where the antenna 300 is at the first start position (ACT1, YES), the processing of the processor 101 proceeds from ACT1 to ACT3.

In ACT2, the processor 101 performs control to cause the antenna 300 to move to the first start position. For example, the processor 101 transmits a movement instruction to the drive device 200. The movement instruction is an instruction to cause the position of the antenna 300 to move to the position A that is the first start position. The processor 201 of the drive device 200 receives a movement instruction from the reading device 100. The processor 201 of the drive device 200 controls, on the basis of the movement instruction, at least one of the first driving device 205 or the second driving device 206 to cause the position of the antenna 300 to move to the first start position.

In ACT3, the processor 101 starts reading the wireless tag 600 by first measurement processing. For example, the processor 101 controls the start of transmitting a radio wave from the antenna 300 at the point of the position A. The antenna 300 starts transmitting a radio wave.

In ACT4, the processor 101 transmits a movement instruction of the first moving stage 213 to the drive device 200. Assumption is made that the movement instruction of the first moving stage 213 is an instruction to cause the antenna 300 to move from the position A that is the first start position to the position B that is the first end position. The processor 101 controls, in accordance with the movement instruction of the first moving stage 213, the drive device 200 to cause the antenna 300 to move from the position A to the position B in the first direction, in the first measurement processing. The processor 201 of the drive device 200 receives the movement instruction of the first moving stage 213 from the reading device 100. The processor 201 of the drive device 200 controls the first driving device 205 to cause the antenna 300 to move from the position A to the position B in the first direction. The first driving device 205 causes the first moving stage 213 to move from the position A to the position B in the first direction to cause the antenna 300 to move from the position A to the position B in the first direction. The antenna 300 is caused to move from the position A to the position B while transmitting a radio wave.

In ACT5, the processor 101 determines whether or not the position of the antenna 300 has reached the position B that is the first end position. For example, the processor 101 may determine, on the basis of the moving velocity of the antenna 300, whether or not the position of the antenna 300 has reached the position B. The processor 101 may determine, on the basis of movement end notification from the drive device 200, that the position of the antenna 300 has reached the position B. The movement end notification may indicate that the position of the antenna 300 has reached the position B.

In the case where the position of the antenna 300 has reached the position B that is the first end position (ACT5, YES), the processing of the processor 101 proceeds from ACT5 to ACT6. In the case where the position of the antenna 300 has not reached the position B that is the first end position (ACT5, NO), the processor 101 continues the processing of ACT5.

In ACT6, the processor 101 finishes reading the wireless tag 600 by the first measurement processing. For example, the processor 101 controls the end of the transmission of a radio wave from the antenna 300 at the point of the position B. The antenna 300 finishes transmitting a radio wave.

The processor 101 acquires, on the basis of movement of the antenna 300 along the first direction, tag data of each wireless tag 600 measured by the demodulation unit 110, in the first measurement processing. The processor 101 acquires a plurality of pieces of tag data of the antenna 300 at a plurality of positions along the first direction. The processor 101 stores, in the first-measurement-data storage area 1111, tag data of the wireless tag 600 in association with the position of the antenna 300 each time tag data of the wireless tag 600 is acquired. The processor 101 can cooperate with the drive device 200 to acquire the position of the antenna 300.

In ACT7, the processor 101 controls the drive device 200 to cause the antenna 300 to move to the intermediate position in the first direction. For example, the processor 101 transmits a movement instruction to the drive device 200. The movement instruction is an instruction to cause the position of the antenna 300 to move to the intermediate position in the first direction. The processor 201 of the drive device 200 receives a movement instruction from the reading device 100. The processor 201 of the drive device 200 controls, on the basis of the movement instruction, the first driving device 205 to cause the position of the antenna 300 to move to the intermediate position in the first direction.

In ACT8, the processor 101 controls the drive device 200 to cause the antenna 300 to move to the position C that is the second start position. For example, the processor 101 transmits a movement instruction to the drive device 200. The movement instruction is an instruction to cause the position of the antenna 300 to move to the position C that is the second start position. The processor 201 of the drive device 200 receives a movement instruction from the reading device 100. The processor 201 of the drive device 200 controls, on the basis of the movement instruction, the second driving device 206 to cause the position of the antenna 300 to move to the second start position.

In ACT9, the processor 101 starts reading the wireless tag 600 by the second measurement processing. For example, the processor 101 controls the start of transmitting a radio wave from the antenna 300 at the point of the position C. The antenna 300 starts transmitting a radio wave.

In ACT10, the processor 101 transmits a movement instruction of the second moving stage 216 to the drive device 200. Assumption is made that the movement instruction of the second moving stage 216 is an instruction to cause the antenna 300 to move from the position C that is the second start position to the position D that is the second end position. The processor 101 controls, in accordance with the movement instruction of the second moving stage 216, the drive device 200 to cause the antenna 300 to move from the position C to the position D in the second direction, in the second measurement processing. The processor 201 of the drive device 200 receives the movement instruction of the second moving stage 216 from the reading device 100. The processor 201 controls the second driving device 206 to cause the antenna 300 to move from the position C to the position D in the second direction. The second driving device 206 causes the second moving stage 216 to move from the position C to the position D in the second direction to cause the antenna 300 to move from the position C to the position D in the second direction. The antenna 300 is caused to move from the position C to the position D while transmitting a radio wave.

As described above, the processor 101 drives the second driving device 206 after finishing driving the first driving device 205 for causing the antenna 300 to move from the position A to the position B in the first direction. The processor 101 starts driving the second driving device 206 for causing the antenna 300 to move from the position C to the position D in the second direction.

In ACT11, the processor 101 determines whether or not the position of the antenna 300 has reached the position D that is the second end position. For example, the processor 101 may determine, on the basis of the moving velocity of the antenna 300, whether or not the position of the antenna 300 has reached the position D. The processor 101 may determine, on the basis of movement end notification from the drive device 200, that the position of the antenna 300 has reached the position D. The movement end notification may indicate that the position of the antenna 300 has reached the position D.

In the case where the position of the antenna 300 has reached the position D that is the second end position (ACT11, YES), the processing of the processor 101 proceeds from ACT11 to ACT12. In the case where the position of the antenna 300 has not reached the position D that is the second end position (ACT11, NO), the processor 101 continues the processing of ACT11.

In ACT12, the processor 101 finishes reading the wireless tag 600 by the second measurement processing. For example, the processor 101 controls the end of the transmission of a radio wave from the antenna 300 at the point of the position D. The antenna 300 finishes transmitting a radio wave.

The processor 101 acquires, on the basis of movement of the antenna 300 along the second direction, tag data of each wireless tag 600 measured by the demodulation unit 110, in the second measurement processing. The processor 101 acquires a plurality of pieces of tag data of the antenna 300 at a plurality of positions along the second direction. The processor 101 stores, in the second-measurement-data storage area 1112, tag data of the wireless tag 600 in association with the position of the antenna 300 each time tag data of the wireless tag 600 is acquired.

In ACT13, the processor 101 determines the position of each wireless tag 600 by the above-mentioned determination processing. For example, the processor 101 outputs the determination result based on the determination processing to the terminal 400. The determination result includes information indicating the position of each wireless tag 600. The determination result may include information stored in each wireless tag 600 read by the reading device 100. The terminal 400 may process the information stored in each wireless tag 600 in accordance with whether or not each wireless tag 600 is included in the first region 81. The terminal 400 may process the information stored in the wireless tag 600 included in the first region 81. The terminal 400 does not necessarily need to process information stored in the wireless tag 600 that is not included in the first region 81.

In ACT14, the processor 101 controls the drive device 200 to cause the antenna 300 to move to the first start position. The processing of ACT14 may be the same as the processing of ACT2.

Although an example in which the first start position is the position A and the first end position is the position B has been described above, the present technology is not limited thereto. The first start position may be the position B and the first end position may be the position A. Although an example in which the second start position is the position C and the second end position is the position D has been described above, the present technology is not limited thereto. The second start position may be the position D and the second end position may be the position C.

Although an example in which the processor 101 controls the drive device 200 to cause the antenna 300 to move to the intermediate position in the first direction in ACT7 has been described, the present technology is not limited thereto. The processor 101 may control the drive device 200 to cause the antenna 300 to move to an arbitrary position in the second direction. The processor 101 may omit the processing of ACT7.

Although an example in which the processor 101 performs processing in the order of first measurement processing along the first direction and second measurement processing along the second direction has been described above, the present technology is not limited thereto. The processing of ACT14 may be omitted. In this example, in the case where the antenna 300 is at the second end position, the processor 101 starts processing starting from the second end position. The processor 101 performs processing in the order of second measurement processing along the second direction and first measurement processing along the first direction.

[Effects]

According to the first embodiment, a communication apparatus includes an antenna for communicating with a wireless tag. The communication apparatus includes a first driving device that causes the antenna to move in a first direction. The communication apparatus includes a second driving device that causes the antenna to move in a second direction different from the first direction. The communication apparatus includes a processor configured to determine a position of the wireless tag on the basis of tag data of the wireless tag acquired on the basis of movement of the antenna along the first direction and tag data of the wireless tag acquired on the basis of movement of the antenna along the second direction. The processor drives second driving device after finishing driving the first driving device. As a result, the communication apparatus is capable of acquiring tag data along two different directions using one antenna to determine the position of the wireless tag. Therefore, the communication apparatus is capable of improving the accuracy of determining the position of the wireless tag without increasing the number of parts.

According to the first embodiment, the first driving device causes the antenna to move from the outside of one end of a predetermined region in the first direction to the outside of the other end in the first direction. The second driving device causes the antenna to move from the outside of one end of the predetermined region in the second direction to the outside of the other end in the second direction. The processor determines whether or not the position of the wireless tag is included in the predetermined region. As a result, the communication apparatus is capable of acquiring tag data on not only the inside of the predetermined region but also the outside of the predetermined region. For this reason, the communication apparatus is capable of determining the position of an inflection point also for the wireless tag in the vicinity of the boundary of the predetermined region. Therefore, the communication apparatus is capable of improving the accuracy of determining the position of the wireless tag.

### Second Embodiment

A second embodiment is different from the first embodiment in which two directions are scanned by one antenna in that two directions are independently scanned by two antennas. Configurations similar to those in the first embodiment will be denoted by the same reference symbols, and description thereof will be omitted. In the second embodiment, portions different from those in the first embodiment will be mainly described. The same components in the drawings will be denoted by the same reference symbols as much as possible, and overlapping description will be omitted.

[Configuration Example]

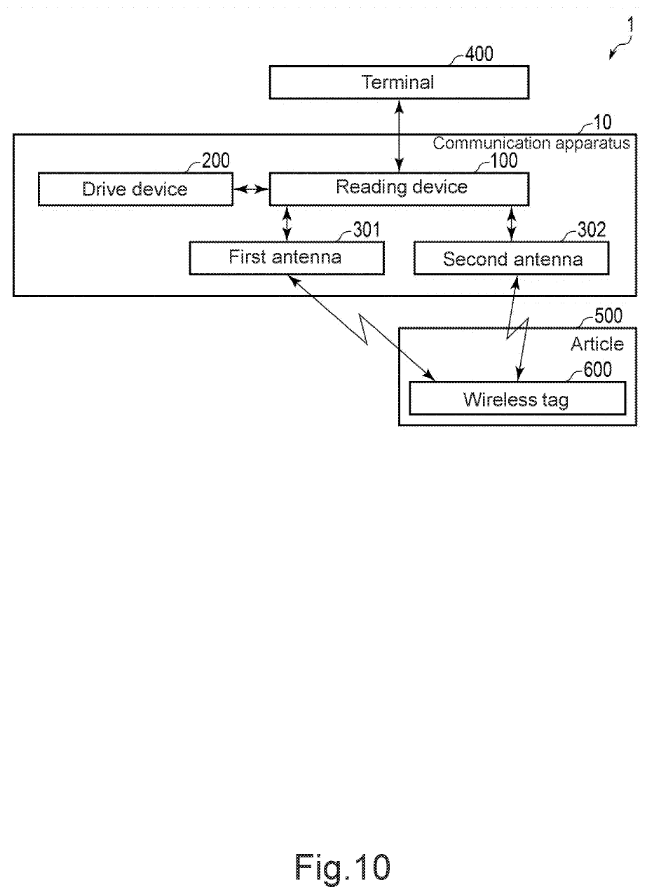

FIG. 10 is a block diagram showing an example of a configuration of the communications system 1. The communication apparatus 10 includes the reading device 100, the drive device 200, a first antenna 301, and a second antenna 302.

The reading device 100 is a device that controls the drive device 200 and the first antenna 301 to read information from the wireless tag 600. The reading device 100 is also a device that controls the drive device 200 and the first antenna 301 to measure tag data of the wireless tag 600. The reading device 100 is a device that controls the drive device 200 and the second antenna 302 to read information from the wireless tag 600. The reading device 100 is also a device that controls the drive device 200 and the second antenna 302 to measure tag data of the wireless tag 600.

The hardware configuration of the reading device 100 may be similar to that in the first embodiment described with reference to FIG. 2. The first-measurement-data storage area 1111 stores first measurement data measured by the demodulation unit 110 on the basis of control of first measurement processing by the processor 101. In the first measurement processing, tag data of the one or more wireless tags 600 based on movement of the first antenna 301 along the first direction is measured unlike the first embodiment. The processor 101 acquires tag data of each of the one or more wireless tags 600 on the basis of movement of the first antenna 301 along the first direction in the first measurement processing. The description of the first measurement data in the first embodiment may be applied to the second embodiment by replacing the notation of the “antenna 300” with the “first antenna 301”. The second-measurement-data storage area 1112 stores second measurement data measured by the demodulation unit 110 on the basis of control of second measurement processing by the processor 101. In the second measurement processing, tag data of the one or more wireless tags 600 based on movement of the second antenna 302 along the second direction is measured unlike the first embodiment. The processor 101 acquires tag data of each of the one or more wireless tags 600 on the basis of movement of the second antenna 302 along the second direction in the second measurement processing. The description of the second measurement data in the first embodiment may be applied to the second embodiment by replacing the notation of the “antenna 300” with the “second antenna 302”.

Now, an example of processing of determining the position of each wireless tag 600 by the processor 101 will be described. The processor 101 determines the position of the wireless tag 600 on the basis of tag data of the wireless tag 600 acquired on the basis of movement of the first antenna 301 along the first direction and tag data of the wireless tag 600 acquired on the basis of movement of the second antenna 302 along the second direction. For example, the processor 101 determines the position of the first antenna 301, which is an inflection point in the first direction, on the basis of a plurality of pieces of tag data of the first antenna 301 at a plurality of positions included in the first tag data set of the wireless tag 600. The position of the first antenna 301, which is an inflection point in the first direction, is a position where the wireless tag 600 is present in the first direction. In the following, the position of the first antenna 301, which is an inflection point in the first direction, will be referred to also as a position of the inflection point in the first direction. The processor 101 determines the position of the second antenna 302, which is an inflection point in the second direction, on the basis of a plurality of pieces of tag data of the second antenna 302 at a plurality of positions included in the second tag data set of the wireless tag 600. The position of the second antenna 302, which is an inflection point in the second direction, is a position where the wireless tag 600 is present in the second direction. In the following, the position of the second antenna 302, which is an inflection point in the second direction, will be referred to also as a position of the inflection point in the second direction. The processor 101 determines the position of the wireless tag 600 on the basis of the position of the inflection point in the first direction and the position of the inflection point in the second direction. Since the processing of determining the position of the wireless tag 600 based on the position of the inflection point in the first direction and the position of the inflection point in the second direction may be similar to that in the first embodiment, description thereof will be omitted.

The drive device 200 is a device that causes the first antenna 301 to move. Causing the first antenna 301 to move includes causing the position of the first antenna 301 to move. The drive device 200 is a device that causes the second antenna 302 to move. Causing the second antenna 302 to move includes causing the position of the second antenna 302 to move.

The drive device 200 causes the first antenna 301 to move between the position A and the position B on a straight line along the first direction. Assumption is made that the position A is the first start position where the first antenna 301 is caused to start moving for first measurement processing, similarly to the first embodiment. Assumption is made that the position B is the first end position where the first antenna 301 is caused to stop moving for first measurement processing, similarly to the first embodiment. The drive device 200 causes the second antenna 302 to move between the position C and the position D on a straight line along the second direction. Assumption is made that the position C the second start position where the second antenna 302 is caused to start moving for second measurement processing, similarly to the first embodiment. Assumption is made that the position D is the second end position where the second antenna 302 is caused to stop moving for second measurement processing, similarly to the first embodiment. A configuration example of the drive device 200 will be described below.

The first antenna 301 communicates with the wireless tag 600. The second antenna 302 communicates with the wireless tag 600. The second antenna 302 is a different antenna different from the first antenna 301. Since the configurations of the first antenna 301 and the second antenna 302 may be similar to the configuration of the antenna 300 in the first embodiment, description thereof will be omitted.

The drive device 200 will be described. The drive device 200 includes the processor 201, the ROM 202, the RAM 203, the connection interface 204, the first driving device 205, the second driving device 206, the first home position sensor 207, and the second home position sensor 208, similarly to the first embodiment described with reference to FIG. 3. Since the configurations of the processor 201, the ROM 202, the RAM 203, the connection interface 204, the first home position sensor 207, and the second home position sensor 208 are similar to those in the first embodiment, description thereof will be omitted. The first driving device 205 causes the first antenna 301 to move in the first direction unlike the first embodiment. The second driving device 206 causes the second antenna 302 to move in the second direction unlike the first embodiment.

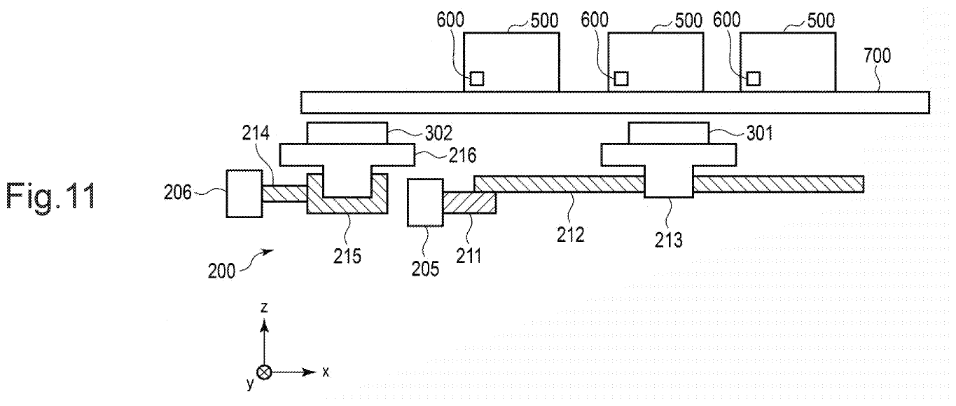

FIG. 11 is a schematic diagram for describing the drive device 200. As illustrated in FIG. 11, the drive device 200, the first antenna 301, and the second antenna 302 are disposed below the counter table 700. The drive device 200 includes the first rotation shaft 211, the first rail 212, the first moving stage 213, the second rotation shaft 214, the second rail 215, and the second moving stage 216.

The first rail 212 extends along the first direction. Here, assumption is made that the direction along the x-axis on the horizontal surface shown in FIG. 11 is the first direction, similarly to the first embodiment. The first moving stage 213 on which the first antenna 301 has been placed is attached to the first rail 212. The first rotation shaft 211 transmits driving force of the first driving device 205. When the first driving device 205 rotates and drives, the first rotation shaft 211 rotates and the first rail 212 rotates. The first moving stage 213 moves in the first direction along the first rail 212 when the first rail 212 rotates. The first moving stage 213 moves back and forth along the first direction in accordance with the rotation direction of the first rail 212. In this way, the first driving device 205 is capable of causing the first antenna 301 to move in the first direction.

The second rail 215 extends in the second direction. Here, assumption is made that the direction along the y-axis on the horizontal surface orthogonal to the x-axis is the second direction, similarly to the first embodiment. Note that the second direction does not necessarily need to be orthogonal to the first direction. The second moving stage 216 on which the second antenna 302 has been placed is attached to the second rail 215. The second rotation shaft 214 transmits driving force of the second driving device 206. When the second driving device 206 rotates and drives, the second rotation shaft 214 rotates and the second rail 215 rotates. The second moving stage 216 moves in the second direction along the second rail 215 when the second rail 215 rotates. The second moving stage 216 moves back and forth along the second direction in accordance with the rotation direction of the second rail 215. In this way, the second driving device 206 is capable of causing the second antenna 302 to move in the second direction.

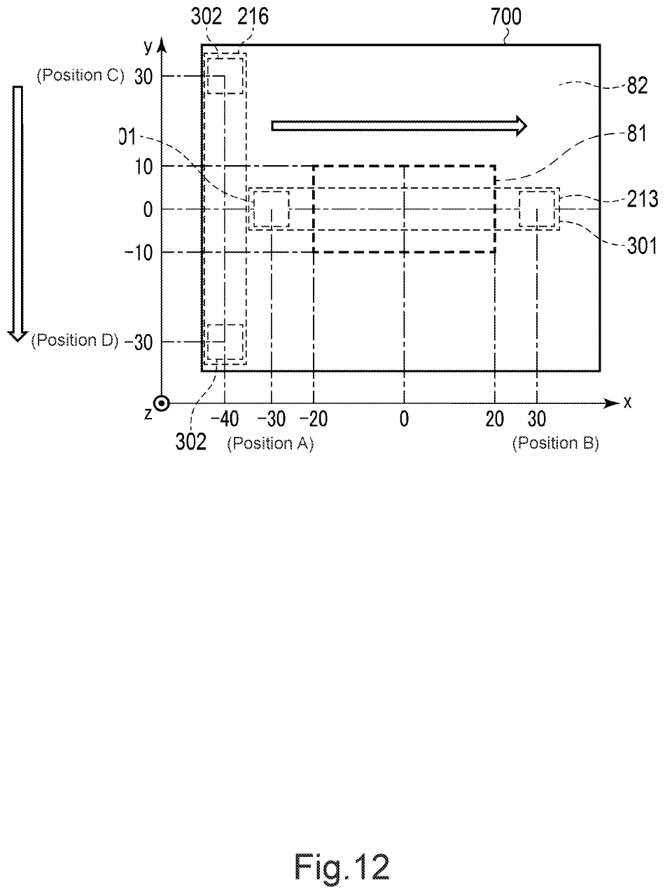

An example of movement of the first antenna 301 and the second antenna 302 will be described. FIG. 12 is a top view for describing movement of the first antenna 301 and the second antenna 302. The x-coordinate and y-coordinate of the first region 81 on the horizontal surface will be described as being similar to those in the first embodiment.

The position of x=−30 [cm] is an example of a position outside the first end of the first region 81 in the first direction, similarly to the first embodiment. Assumption is made that the position outside the first end of the first region 81 in the first direction is the position A. The position of x=30 [cm] is an example of a position outside the second end of the first region 81 in the first direction, similarly to the first embodiment. Assumption is made that the position outside the second end of the first region 81 in the first direction is the position B.

The position of y=30 [cm] is an example of a position outside the first end of the first region 81 in the second direction, similarly to the first embodiment. Assumption is made that the position outside the first end of the first region 81 in the second direction is the position C. The position of y=−30 [cm] is an example of a position outside the second end of the first region 81 in the second direction, similarly to the first embodiment. Assumption is made that the position outside the second end of the first region 81 in the second direction is the position D.

The first driving device 205 causes the first antenna 301 to move from the outside of one end of the first region 81 in the first direction to the outside of the other end in the first direction in first measurement processing. FIG. 12 shows an example of the trajectory of the first moving stage 213 that causes the first antenna 301 to move. A case where the first start position is the position A and the first end position is the position B will be described. The first driving device 205 causes the first antenna 301 to move from the position A outside the first end of the first region 81 in the first direction to the position B outside the second end of the first region 81 in the first direction. Note that the first start position and the first end position may be reversed. In this example, the first start position is the position B and the first end position is the position A. The first driving device 205 causes the first antenna 301 to move from the position B outside the second end of the first region 81 in the first direction to the position A outside the first end of the first region 81 in the first direction.

Although the first driving device 205 causes the first antenna 301 to move in the first direction so as to face, in the vertical direction, the intermediate position of the first region 81 in the second direction in the example of FIG. 12, the present technology is not limited thereto. The first driving device 205 may cause the first antenna 301 to move in the first direction so as to face, in the vertical direction, an arbitrary position of the first region 81 in the second direction. The first driving device 205 may cause the first antenna 301 to move in the first direction without facing the first region 81 in the vertical direction.

The second driving device 206 causes the second antenna 302 to move from the outside of one end of the first region 81 in the second direction to the outside of the other end in the second direction in the second measurement processing. FIG. 12 shows an example of the trajectory of the second moving stage 216 that causes the second antenna 302 to move. A case where the second start position is the position C and the second end position is the position D will be described. The second driving device 206 causes the second antenna 302 to move from the position C outside the first end of the first region 81 in the second direction to the position D outside the second end of the first region 81 in the second direction. Note that the second start position and the second end position may be reversed. In this example, the second start position is the position D and the second end position is the position C. The second driving device 206 causes the second antenna 302 to move from the position D outside the second end of the first region 81 in the second direction to the position C outside the first end of the first region 81 in the second direction.

Although the second driving device 206 causes the second antenna 302 to move in the second direction without facing the first region 81 in the vertical direction in the example of FIG. 12, the present technology is not limited thereto. The second driving device 206 may cause the second antenna 302 to move in the second direction so as to face, in the vertical direction, the intermediate position of the first region 81 in the first direction. The second driving device 206 may cause the second antenna 302 to move in the second direction so as to face, in the vertical direction, an arbitrary position of the first region 81 in the first direction.

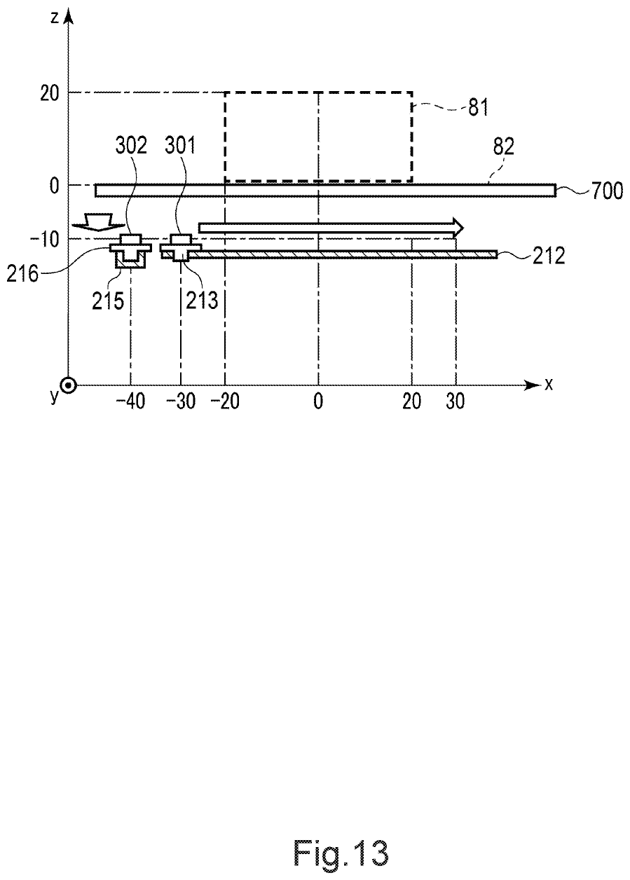

FIG. 13 is a side view for describing movement of the first antenna 301 and the second antenna 302. The position of the first antenna 301 in the vertical direction and the position of the second antenna 302 in the vertical direction are the same. The second rail 215 and the second moving stage 216 are provided at positions in the first direction different from positions between the position A and the position B where the first moving stage 213 on which the first antenna 301 has been placed moves. In the example shown in FIG. 13, the second rail 215 extends in the second direction at the position of x=−40 [cm]. As a result, the first antenna 301 moves in the first direction and the second antenna 302 moves in the second direction at the same position in the vertical direction. The second antenna 302 moves in the second direction without facing the first region 81 in the vertical direction.

Note that the position of the first antenna 301 in the vertical direction and the position of the second antenna 302 in the vertical direction may be different from each other. The position of the second antenna 302 in the vertical direction may be a position lower than that of the first antenna 301 or a position higher than that of the first antenna 301. In this example, the second rail 215 is provided so as to face the first rail 212 in the vertical direction. For this reason, both the first rail 212 and the second rail 215 can be provided so as to face the first region 81 in the vertical direction. The second antenna 302 is capable of moving in the second direction so as to face the first region 81 in the vertical direction.

Next, processing performed by the processor 101 of the reading device 100 configured as described above will be described. Note that the processing procedure described below is merely an example, and each process may be changed as much as possible. Further, in the processing procedure described below, Steps can be omitted, replaced, and added as appropriate in accordance with the embodiment.

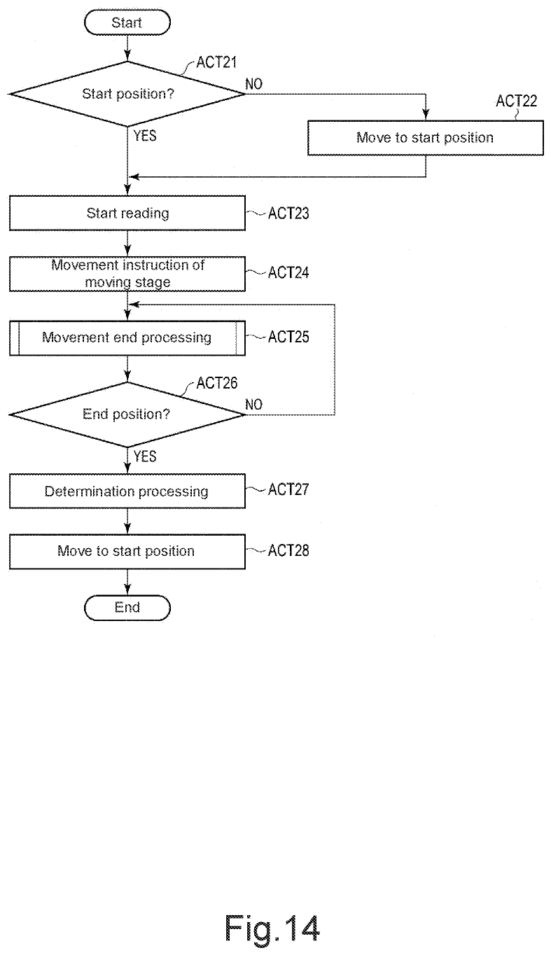

FIG. 14 is a flowchart showing an example of processing performed by the processor 101 of the reading device 100.

For example, assumption is made that the one or more articles 500 to which the one or more wireless tags 600 have been attached are placed on the counter table 700. Note that the one or more articles 500 to which the one or more wireless tags 600 have been attached do not necessarily need to be placed on the counter table 700. Part or all of the one or more wireless tags 600 may be present in the vicinity of the counter table 700.

The processor 101 may start processing on the basis of the acquisition of an instruction to start processing input by a user through the terminal 400.

In ACT21 of FIG. 14, the processor 101 determines whether or not an antenna is at a start position. The fact that the antenna is at the start position indicates that the first antenna 301 is at the position A that is the first start position and the second antenna 302 is at the position C that is the second start position. In the case where the antenna is not at the start position (ACT21, NO), the processing of the processor 101 proceeds from ACT21 to ACT22. In the case where the antenna is at the start position (ACT21, YES), the processing of the processor 101 proceeds from ACT21 to ACT23.

In ACT22, the processor 101 performs control to cause the antenna to move to the start position. For example, the processor 101 transmits a movement instruction to the drive device 200. Assumption is made that the movement instruction includes an instruction to cause the position of the first antenna 301 to move to the position A that is the first start position. Assumption is made that the movement instruction includes an instruction to cause the position of the second antenna 302 to move to the position C that is the second start position. The processor 201 of the drive device 200 receives a movement instruction from the reading device 100. In the case where the first antenna 301 is not at the first start position, the processor 201 of the drive device 200 controls, on the basis of the movement instruction, the first driving device 205 to cause the position of the first antenna 301 to move to the first start position. In the case where the second antenna 302 is not at the second start position, the processor 201 of the drive device 200 controls, on the basis of the movement instruction, the second driving device 206 to cause the position of the second antenna 302 to move to the second start position.

In ACT23, the processor 101 starts reading the wireless tag 600. For example, the processor 101 starts reading the wireless tag 600 by first measurement processing. The processor 101 controls the start of transmitting a radio wave from the first antenna 301 at the point of the position A. The first antenna 301 starts transmitting a radio wave. The processor 101 starts reading the wireless tag 600 by second measurement processing. The processor 101 controls the start of transmitting a radio wave from the second antenna 302 at the point of the position C. The second antenna 302 starts transmitting a radio wave. The processor 101 controls the reading of the wireless tag 600 while alternately switching the transmission of a radio wave from the first antenna 301 and the transmission of a radio wave from the second antenna 302.

In ACT24, the processor 101 transmits a movement instruction of a moving stage to the drive device 200. Assumption is made that the movement instruction of a moving stage includes a movement instruction of the first moving stage 213 for causing the first antenna 301 to move from the position A that is the first start position to the position B that is the first end position. The processor 101 controls, in accordance with the movement instruction of the first moving stage 213, the drive device 200 to cause the first antenna 301 to move from the position A to the position B in the first direction, in the first measurement processing. The processor 201 of the drive device 200 receives a movement instruction of the first moving stage 213 from the reading device 100. The processor 201 of the drive device 200 controls the first driving device 205 to cause the first antenna 301 to move from the position A to the position B in the first direction. The first driving device 205 causes the first moving stage 213 to move from the position A to the position B in the first direction to cause the first antenna 301 to move from the position A to the position B in the first direction. The first antenna 301 moves from the position A to the position B while transmitting a radio wave. Assumption is made that the movement instruction of a moving stage includes a movement instruction of the second moving stage 216 for causing the second antenna 302 to move from the position C that is the second start position to the position D that is the second end position. The processor 101 controls, in accordance with the movement instruction of the second moving stage 216, the drive device 200 to cause the second antenna 302 to move from the position C to the position D in the second direction, in the second measurement processing. The processor 201 of the drive device 200 receives a movement instruction of the second moving stage 216 from the reading device 100. The processor 201 of the drive device 200 controls the second driving device 206 to cause the second antenna 302 to move from the position C to the position D in the second direction. The second driving device 206 causes the second moving stage 216 from the position C to the position D in the second direction to cause the second antenna 302 to move from the position C to the position D in the second direction. The second antenna 302 moves from the position C to the position D while transmitting a radio wave.

In this way, the processor 101 is capable of independently controlling the movement of the first antenna 301 and the movement of the second antenna 302. The processor 101 is capable of simultaneously driving the first driving device 205 and the second driving device 206 to cause the first antenna 301 and the second antenna 302 to simultaneously move in different directions. Simultaneously driving the devices is not limited to simultaneously starting driving the devices. Simultaneously driving the devices may include driving the devices such that the time for causing the first antenna 301 to move in the first direction and the time for causing the second antenna 302 to move in the second direction partially overlap with each other.

In ACT25, the processor 101 executes movement end processing. The movement end processing includes processing of finishing the reading of the wireless tag 600 in the first measurement processing involved in the movement of the first antenna 301. The movement end processing includes processing of finishing the reading of the wireless tag 600 in the second measurement processing involved in the movement of the second antenna 302. The movement end processing will be described below.

In ACT26, the processor 101 determines whether or not the position of the first antenna 301 has reached the position B that is the first end position and the position of the second antenna 302 has reached the position D that is the second end position. In the case where both the first antenna 301 and the second antenna 302 have reached the end positions (ACT26, YES), the processing of the processor 101 proceeds from ACT26 to ACT27. In the case where at least one of the first antenna 301 or the second antenna 302 has not reached the end position (ACT26, NO), the processing of the processor 101 proceeds from ACT26 to ACT25.

In ACT27, the processor 101 determines the position of each wireless tag 600 by the above-mentioned determination processing. The processing of ACT27 may be the same as the processing of ACT13 described in the first embodiment.

In ACT28, the processor 101 performs control to cause an antenna to move to the start position. The processing of ACT28 may be the same as the processing of ACT22.

Although an example in which the first start position is the position A and the first end position is the position B has been described above, the present technology is not limited thereto. The first start position may be the position B and the first end position may be the position A. Although an example in which the second start position is the position C and the second end position is the position D has been described above, the present technology is not limited thereto. The second start position may be the position D and the second end position may be the position C.

The processing of ACT28 may be omitted. In this example, in the case where the first antenna 301 is at the first end position, the processor 101 starts processing starting from the first end position. In the case where the second antenna 302 is at the second end position, the processor 101 starts processing starting from the second end position.

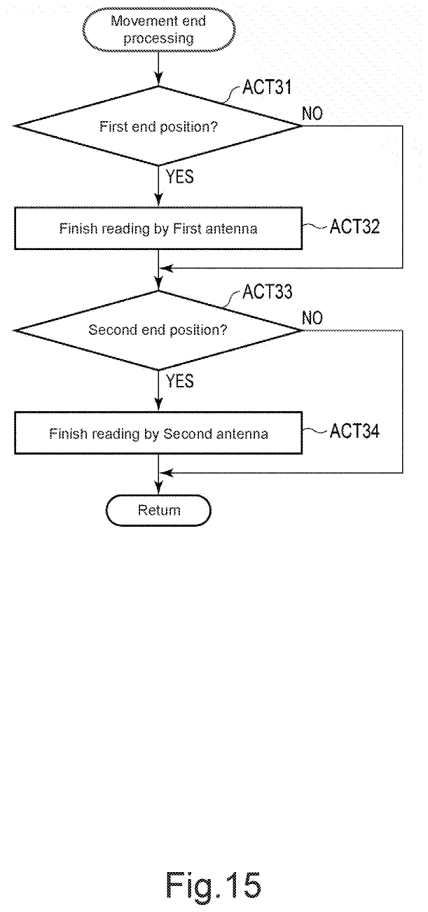

The movement end processing of ACT25 shown in FIG. 14 will be described. FIG. 15 is a flowchart showing an example of movement end processing performed by the processor 101 of the reading device 100.

In ACT31 of FIG. 15, the processor 101 determines whether or not the position of the first antenna 301 has reached the position B that is the first end position. In the case where the position of the first antenna 301 has reached the position B that is the first end position (ACT31, YES), the processing of the processor 101 proceeds from ACT31 to ACT32. In the case where the position of the first antenna 301 has not reached the position B that is the first end position (ACT31, NO), the processing of the processor 101 proceeds from ACT31 to ACT33.

In ACT32, the processor 101 finishes reading the wireless tag 600 by the first measurement processing involved in the movement of the first antenna 301. For example, the processor 101 controls the end of the transmission of a radio wave from the first antenna 301 at the point of the position B. The first antenna 301 finishes transmitting a radio wave.

The processor 101 acquires, on the basis of the movement of the first antenna 301 along the first direction, tag data of each wireless tag 600 measured by the demodulation unit 110, in the first measurement processing. The processor 101 acquires a plurality of pieces of tag data of the first antenna 301 at a plurality of positions along the first direction. The processor 101 stores, in the first-measurement-data storage area 1111, tag data of the wireless tag 600 in association with the position of the first antenna 301 each time tag data of the wireless tag 600 is acquired.

In ACT33, the processor 101 determines whether or not the position of the second antenna 302 has reached the position D that is the second end position. In the case where the position of the second antenna 302 has reached the position D that is the second end position (ACT33, YES), the processing of the processor 101 proceeds from ACT33 to ACT34. In the case where the position of the second antenna 302 has not reached the position D that is the second end position (ACT33, NO), the processing of the processor 101 proceeds from ACT33 to ACT26 shown in FIG. 14.

In ACT34, the processor 101 finishes reading the wireless tag 600 by the second measurement processing involved in the movement of the second antenna 302. For example, the processor 101 controls the end of the transmission of a radio wave from the second antenna 302 at the point of the position D. The second antenna 302 finishes transmitting a radio wave.

The processor 101 acquires, on the basis of the movement of the second antenna 302 along the second direction, tag data of each wireless tag 600 measured by the demodulation unit 110, in the second measurement processing. The processor 101 acquires a plurality of pieces of tag data of the second antenna 302 at a plurality of positions along the second direction. The processor 101 stores, in the second-measurement-data storage area 1112, tag data of the wireless tag 600 in association with the position of the second antenna 302 each time tag data of the wireless tag 600 is acquired.

[Effects]

According to the second embodiment, a communication apparatus includes two antennas for communicating with a wireless tag. The communication apparatus includes a first driving device that causes the antenna to move in a first direction. The communication apparatus includes a second driving device that causes a different antenna to move in a second direction different from the first direction. The communication apparatus includes a processor configured to determine a position of the wireless tag on the basis of tag data of the wireless tag acquired on the basis of movement of the antenna along the first direction and tag data of the wireless tag acquired on the basis of movement of the different antenna along the second direction. The processor simultaneously drives the first driving device and the second driving device. As a result, the communication apparatus is capable of causing the two antennas to independently move along two different directions. The communication apparatus is capable of acquiring tag data along the two different directions using the two antennas to determine the position of the wireless tag. The communication apparatus is capable of improving the accuracy of determining the position of the wireless tag while shortening the time for acquiring tag data along two different directions.

According to the second embodiment, the first driving device causes the antenna to move from the outside of one end of a predetermined region in the first direction to the outside of the other end in the first direction. The second driving device causes the different antenna to move from the outside of one end of the predetermined region in the second direction to the outside of the other end in the second direction. The processor determines whether or not the position of the wireless tag is included in the predetermined region. As a result, the communication apparatus is capable of acquiring tag data on not only the inside of the predetermined region but also the outside of the predetermined region. For this reason, the communication apparatus is capable of determining the position of an inflection point also for the wireless tag in the vicinity of the boundary of the predetermined region. Therefore, the communication apparatus is capable of improving the accuracy of determining the position of the wireless tag.

According to the second embodiment, the position of the antenna in the vertical direction and the position of the different antenna in the vertical direction are the same. As a result, the distances from the two antennas to the wireless tag in the vertical direction are the same. For this reason, the communication apparatus is capable of reducing the possibility that the wireless tag cannot be read by one antenna of the two antennas although the wireless tag can be read by the other antenna. Further, in the communication apparatus, since two antennas do not need to be provided at different positions in the vertical direction, it is possible to prevent the size of the communication apparatus in the vertical direction from increasing.

### Other Embodiments

Although an example in which the antenna is an antenna capable of transmitting and receiving a radio wave has been described in the above-mentioned embodiment, the present technology is not limited thereto. The antenna may include an antenna for transmitting a radio wave and an antenna for receiving a radio wave.

The communication apparatus may be realized by a plurality of devices as described in the above-mentioned example, or may be realized by one apparatus integrating functions of a plurality of devices. The reading device, the drive device, and the antenna may be realized by one device integrating functions. The reading device may be realized by a plurality of devices with distributed functions.

The program may be transferred while being stored in a device according to an embodiment or may be transferred without being stored in a device. In the latter case, the program may be transferred via a network or may be transferred while being recorded on a recording medium. The recording medium is a non-transitory tangible medium. The recording medium is a computer-readable medium. The recording medium only needs to be a medium that is capable of storing a program, such as a CD-ROM and a memory card, and is readable by a computer, and the form thereof does not matter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus, comprising:
one or more antennas that communicate with a wireless tag;
a first driving device that causes an antenna to move in a first direction;
a second driving device that causes the antenna or a different antenna different from the antenna in a second direction different from the first direction; and
a processor configured to determine a position of the wireless tag on a basis of tag data of the wireless tag acquired on a basis of movement of the antenna along the first direction and tag data of the wireless tag acquired on a basis of movement of the antenna or the different antenna along the second direction.

2. The communication apparatus according to claim 1, wherein
the first driving device causes the antenna to move from outside of one end of a predetermined region in the first direction to outside of the other end in the first direction.

3. The communication apparatus according to claim 2, wherein
the second driving device causes the antenna or the different antenna to move from outside of one end of the predetermined region in the second direction to outside of the other end in the second direction.

4. The communication apparatus according to claim 3, wherein
the processor is further configured to determine whether or not the position of the wireless tag is included in the predetermined region.

5. The communication apparatus according to claim 1, wherein
the first driving device includes a motor that causes the antenna to move in the first direction, and
the second driving device includes a motor that causes the antenna to move in the second direction.

6. The communication apparatus according to claim 5, wherein
the processor is further configured to drive the second driving device after finishing driving the first driving device.

7. The communication apparatus according to claim 3, wherein
the first driving device includes a motor that causes the antenna to move in the first direction,
the second driving device includes a motor that causes the antenna to move in the second direction, and
the processor is further configured to drive the second driving device after finishing driving the first driving device.

8. The communication apparatus according to claim 1, wherein
the first driving device includes a motor that causes the antenna to move in the first direction, and
the second driving device includes a motor that causes the different antenna to move in the second direction.

9. The communication apparatus according to claim 8, wherein
the processor is further configured to simultaneously drive the first driving device and the second driving device.

10. The communication apparatus according to claim 1, wherein
a position of the antenna in a vertical direction and a position of the different antenna in the vertical direction are the same,
the first driving device includes a motor that causes the antenna to move in the first direction,
the second driving device includes a motor that causes the different antenna to move in the second direction, and
the processor is further configured to simultaneously drive the first driving device and the second driving device.
